(19) United States
(12) Patent Application Publication
(10) Pub. No.: US 2025/0170783 A1
(43) Pub. Date: May 29, 2025

(54) IMAGING AND FEEDBACK FOR VOLUMETRIC PRINTING

(71) Applicant: NATIONAL RESEARCH COUNCIL OF CANADA, Ottawa (CA)

(72) Inventors: Antony ORTH, Ottawa (CA); Kathleen SAMPSON, Ottawa (CA); Chantal PAQUET, Ottawa (CA); Jonathan BOISVERT, Ottawa (CA); Yujie ZHANG, Ottawa (CA)

(21) Appl. No.: 18/834,329

(22) PCT Filed: Jan. 31, 2023
(86) PCT No.: PCT/IB2023/050836

§ 371 Date: Jul. 30, 2024

Related U.S. Application Data
(60) Provisional application No. 63/305,331, filed on Feb. 1, 2022.

(51) Int. Cl. B29C 64/393; B29C 64/241; B29C 64/286; B33Y 10/00; B33Y 50/02

(52) U.S. Cl. CPC B29C 64/393; B29C 64/241; B29C 64/286; B33Y 10/00; B33Y 50/02

(57) ABSTRACT

Volumetric Additive Manufacturing allows for the rapid printing of objects by transmitting images into a reservoir holding resin, using wavelengths of light associated with a photocuring characteristic of the resin. Feedback based control can be enabled through the use of optical scattering tomography based imaging of the object during the printing process. Through capturing a set of images representing the scattering of a non-curing light, an isosurface representing the object during printing can be generated. The differences between the isosurface and the expected shape of the object can be used as an input into a control process or they can be displayed to an operator so that printing can be terminated when the printing of the object is complete.

### CROSS REFERENCE TO RELATED APPLICATIONS

This is application claims priority to U.S. Patent Application No. 63/305,331, filed Feb. 1, 2022, the contents of which are incorporated herein by reference.

### TECHNICAL FIELD

This application relates generally to a control system for use with additive manufacturing, and more particularly to a feedback driven control system for use in volumetric printing.

### BACKGROUND

Additive manufacturing, also referred to as 3-D printing, has found a role in the rapid production of items in many fields including the development of prototypes. The underlying technologies behind additive manufacturing include filament driven printing systems that melt or fuse a (typically plastic) filament to build a three dimensional object in what is effectively a pixel by pixel process. Filament driven printing systems make use of a gantry that moves in two dimensions across a platen that is typically raised or lowered to allow for a three dimensional object to be built up. For some objects, printing requires supports to be added to allow the printed object to be formed, and they are then typically removed by an operator after printing. Among the known issues with this technology are both a slow printing speed and a somewhat coarse resolution that is apparent on curved surfaces. Although there are no workarounds to the print speed, many users have developed workflows that include a manual polishing phase that includes the removal of the required printing supports as well as smoothing otherwise stair-stepped curves.

Improvements in 3D printing technologies have been directed at a number of different mechanisms to improve both printing speed and the ability to address issues associated with the coarseness of printing curved surfaces. As opposed to the one dimensional printing system provided by filament based printing systems, two dimensional printing systems making use of layering and then sintering powdered resin have been developed that allow for printing without supports. In these systems, the unsintered resin serves as a support, and printing happens row-by-row instead of pixel-by-pixel. This can dramatically reduce print times, which can be attributed to both a change in technology as well as the increase in the effective size of a print head.

In a more recent development, volumetric additive manufacturing (VAM), also referred to as volumetric printing, has been developed. A liquid resin is used as source material, and is exposed to light. The resin is designed to cure in response to exposure to certain wavelengths of light. By controlling the wavelength of light, and the power of a light source, printing a three-dimensional object can be achieved by projecting images into a resin tank from different angles. The images projected into the resin can cause a photocurable resin to begin curing.

Where previous additive manufacturing techniques built objects in a time-consuming layer-by-layer fashion, VAM can be used to create objects with complex geometries in a much faster fashion. To do so, it is necessary to be able to determine what the object looks like from different perspectives, and if an internal structure is needed, it may also be necessary to have a view of what different sections of the object look like from different angles.

FIG. 1 illustrates an example of a VAm system 50, where a reservoir 52 of resin is in the field of projection of a light source, projector 54. Projector 54 transmits an image 56 into reservoir 52. Image 56 is defined using wavelengths of light known to cause the photocurable resin within reservoir 52 to begin a curing process. The reservoir 52 can be rotated (in other embodiments the reservoir 52 can be held fixed, and the projector 54 can be rotated about the reservoir 52). This rotation is paired with changing the projected image 56 so that the image reflects what the final object 58 looks like from different angles.

FIG. 2 illustrates how the reservoir 52 containing a photocurable resin uses images 56i-56m to set the image of the final object 58. To control an internal structure of the final object 58, a view of the object in section can be projected. When the structure has been sufficiently set, a new image of the object in section, but at a different position can be used. To understand this, it may be beneficial to consider imaging techniques such as computer aided tomography (CAT) where a solid object is imaged to create a model of the object that is built up based on sections of the object. The image of a section of the object can then be brought together to create a model. This is a known imaging technique often used in medical imaging.

In VAM, complex geometries can be generated using a tomography process that can be thought of as an inverse to the CAT process. Where CAT starts with a solid object and builds a model based on images that form sections of the object, a VAM tomographic process starts with a model. The object is created by projecting images into a reservoir of resin. The projected images are created by creating sections of the model, from a given angle, and then projecting the image into the resin. As the resin within the reservoir is illuminated above a gelation threshold, the resin begins a solidification process.

VAM is a notably faster printing process than other additive manufacturing techniques, and curved surfaces can be easily generated without the stair-step effect of previous techniques. However, control of the VAM process is different than it would be in previous techniques due to a number of different environmental factors. The projection of light into a reservoir must not be stopped early, or the object will lack definition. However, because exposure to the projected light causes the resin to cure, if the projection is stopped too late, overprinting occurs and the final object will lack fidelity.

To identify the correct moment to stop printing a feature, characteristics of the resin and the overall requirements must be known. Different resin makeup between prints may result in different timings, as could other environmental factors. To determine if the internal structure of an object is properly rendered, testing must be performed. This testing could be destructive, e.g. physically slicing an object to examine sections, or it could be non-destructive such as the use of X-ray imaging. Destructive testing can be expensive due to the destruction of what may be an otherwise good print, while non-destructive testing will often be more expensive. In some current processes, an operator will look for visual cues to indicate that a printed object is finished, and can stop the printing process. This process is typically not reproducible as it depends on a judgement made by an operator, and it is typically most effective when done with respect to the outer surface of an object.

FIG. 1 illustrates the use of an optional imaging system 62, oriented about the same axis 60 as the projector 54. This optional imaging system 62 has been proposed as a mechanism to determine when the printing process is complete. It relies upon a known phenomenon referred to as Schlieren imaging or Schlieren photography. Schlieren imaging makes use of changes to the refractive index of the resin during the curing process. When light from the projector 54 enters the reservoir 52 it will experience a change in direction caused by the difference in the refractive index between the air outside the reservoir 52 and the material (often glass) from which the reservoir 52 is made. There is then another change in direction caused by the difference in the refractive indices of the reservoir material and the resin. As the light continues along, it will be refracted again as it passes through the interface between the resin and the reservoir, and again by the interface between the reservoir and the air. If all the refractive indices are known, the divergence of the light from its initial path can be calculated. Thus, light that travels along the principal axis 60 of the projector will be offset from this axis when it is captured by the imaging system 62, as shown by secondary axis 64 which is effectively parallel to the principal axis 60. As the resin is cured by exposure to the light from projector 54, it undergoes a polymerization process, which has the side effect of changing its refractive index. As the object 58 begins to take shape, there is a notable change in the refractive index of the resin forming the object 58. This causes a change in the direction of light passing through the reservoir 52. This causes a shift of the secondary axis 64 which can be detected as a change in the offset from the principal axis 60. These behaviors can be modelled to create a threshold so that when the secondary axis 64 shifts from an initial position to a threshold position, the printing process can be stopped.

Although only some of the resin within reservoir 52 is cured into a solid object, the exposure of the uncured resin to the light may result in some of the uncured resin undergoing a degree of polymerization. This polymerization can manifest in a number of physical changes to the resin, including a change in the viscosity of the resin and a change in the refractive index of the resin. Unfortunately, these changes in the resin caused by polymerization are difficult to accurately predict due to unknown aspects of the kinetics associated with the curing process. Furthermore, the properties of the resin may vary from batch to batch, making changes in the refractive index difficult to model. It should also be understood that the offset of the secondary axis 64 from the principal axis 60 is a function of the differences in each of the refractive indices and the overall size of the reservoir 52. With small reservoirs, and uncertain differences in the refractive indices, along changes in the refractive index of portions of the resin that are difficult to model, the offset between the axes 60 and 64 is both small and somewhat uncertain. As a result, this measurement of the changes in the refractive index of the system is difficult to accurately associate with a specific change in physical state. This uncertainty makes the use of this measurement difficult and possibly inaccurate, making it non-ideal for use as an input to a real time control system.

It would therefore be beneficial to have a mechanism to allow for in-print monitoring so that VAM can be carried out to provide control over the structure of a printed object.

### SUMMARY

It is an object of the aspects of the present invention to obviate or mitigate the problems of the above-discussed prior art.

In a first aspect of the present invention, there is provided an optical scattering tomography (OST) system. This OST system allows for the imaging of an object, within a resin reservoir, that is formed by light from a projector. The OST system comprises a light source, a camera and a reconstruction engine. The light source illuminates the object within the resin reservoir with light having a known wavelength. The camera is used to capture an image associated with scattering of the light from the light source by the object in the resin reservoir. The reconstruction engine allows for the assembly of a model that represents the object. The model is assembled in accordance with a plurality of captured images from the camera.

In an embodiment of the first aspect, the light source and the camera are oriented along independent axes. In some embodiments, these axes are substantially orthogonal to each other. In further embodiments, each of the projector, the light source and the camera are oriented along mutually orthogonal axes.

In another embodiment, the light source is one of a Light Emitting Diode, a laser, and a filtered light source. In other embodiments, the projector projects an image into the resin reservoir, the image determined in accordance with the model of the object. In further embodiments, the light from the projector has a wavelength between ultraviolet and blue and optionally is between 100 nm and 500 nm. In some embodiments, the light from the projector has an associated wavelength different than the known wavelength of the light from the light source.

In another embodiment, the OST system of the first aspect further comprises a resin within the resin reservoir. This resin is photocurable in response to exposure to a wavelength of light associated with the light from the projector. The resin is not photocurable to the known wavelength of light from the light source. In some embodiments, the resin is photocurable in response to exposure to a wavelength of light between 100 nm and 500 nn, and the known wavelength of light from the light source is between 550 nm and 1000 nm.

In another embodiment, the known wavelength of the light from the light source is between red and near-infrared. In some embodiments, the wavelength is between 620 nm and 630 nm.

In further embodiments, the OST system further comprises a spectral filter between the reservoir and the camera. In some embodiments, this spectral filter is a bandpass filter centered about the known wavelength the light from the light source. In some embodiments, the filter passes light having a wavelength between 620 nm and 630 nm.

In some embodiments, the resin reservoir rotates with respect to the camera and the projector. In other embodiments the reconstruction engine generates the model in accordance with three dimensional scattering density information determined in accordance with a plurality of images captured by the camera.

In some embodiments the assembled model representative of the object is an isosurface representative of the object. Optionally, the three dimensional scattering density information includes information associated with the brightness of light scattered by the object.

In some embodiments, the output of the reconstruction engine is displayed to an operator. Optionally, the output of the comparison engine is a graphical representation of the isosurface and the model. In other embodiments, the output of the reconstruction engine is a numerical representation of the difference between the model and the isosurface.

In another embodiment, the output of the reconstruction engine is provided as an input to a projector control system. Optionally, the projector control system terminates the projection of light into the reservoir in accordance with the output of the reconstruction engine. In other embodiments, the projector control system controls light output by the projector in accordance with the model of the object and the output of the reconstruction engine.

In some embodiments, the OST further comprises a comparison engine for generating an output representative of a difference between a model of the object and the isosurface assembled by the reconstruction engine.

### BRIEF DESCRIPTION OF THE DRAWINGS

Embodiments of the present invention will now be described in further detail by way of example only with reference to the accompanying figure in which:

FIG. 1 is an illustration of a prior art Volumetric Additive Manufacturing system;

FIG. 2 is an illustration of the projection of multiple images into a resin reservoir in the Volumetric Additive Manufacturing process of FIG. 1;

FIG. 3 is an illustration of an Optical Scattering Tomography system in conjunction with a Volumetric Additive Manufacturing system, according to an embodiment;

FIGS. 4A and 4B are illustrations of refraction of scattered illumination with respect to physical and virtual cameras, according to an embodiment;

FIG. 5 is an illustration of a process for reconstructing scattering density, according to an embodiment;

FIGS. 6a-6d illustrate the assembly of a isosurface in accordance with obtained scattering density information, according to an embodiment; and

FIG. 7 illustrates the evolution of a print based on OST imaging, according to an embodiment.

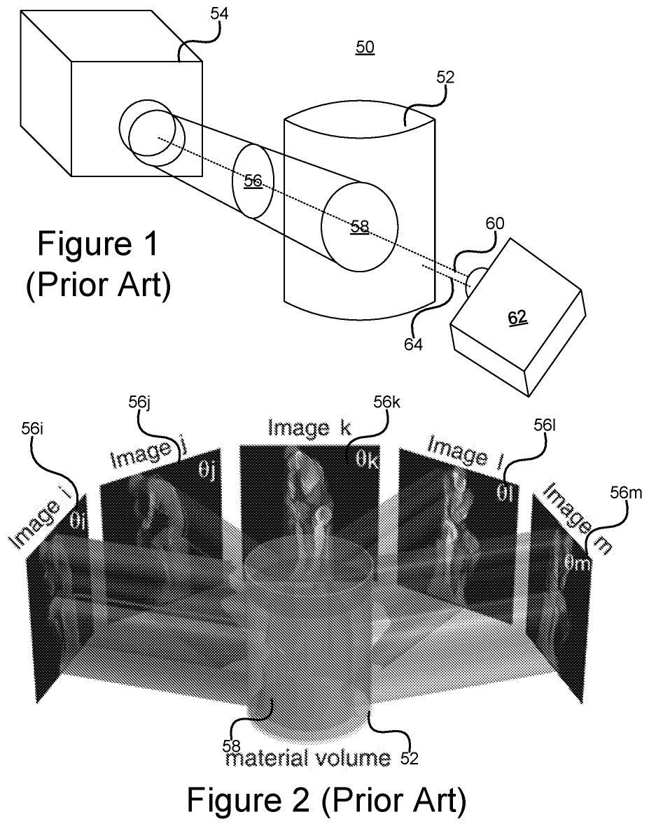

Where possible, in the above figures, like reference numerals have been used for like elements across the figures.

### DETAILED DESCRIPTION

In the instant description, and in the accompanying figures, reference to dimensions may be made. These dimensions are provided for the enablement of a single embodiment and should not be considered to be limiting or essential.

To address problems in the prior art, a volumetric printing system is discussed below that makes use of a feedback-based control system that allows for differences in the rate or effectiveness of the curing of the resin to be accommodated. This allows for real-time or near real time control of the projection of light into the reservoir to cure resin.

Before beginning a discussion of the details of a feedback-based control system, it is helpful to understand what is happening during a VAM printing process. The resin is designed to cure in the presence of a set of wavelengths of light. As this curing happens, the energy of the light is absorbed by the resin to allow for a chemical change to occur. This chemical change results in the curing of the resin. It should be understood that the cured resin has different physical characteristics than the uncured resin, the easiest of such changes to detect is that the uncured resin is typically a viscous liquid, while the cured resin is solid. The curing does not necessarily occur simply in the presence of light, but instead the resin is sensitive to particular wavelengths of light, and also requires a minimum dose of the light to begin the curing process. As a portion of the resin begins to cure, other volumes of resin within the reservoir will remain liquid. As the printed object takes shape, its form is typically visible through the resin, although it should be understood that the uncured resin may effectively cause interference that impairs the ability to clearly see the set form of the object as it is formed. Furthermore, the light that is shone into the resin reservoir is absorbed by the resin itself, and may not provide sufficient illumination to allow for sufficient observation of the curing process. The light shone into the resin should also not be obscured. The forming object will also act to obscure the light that is being shone through the resin.

With these impairments to observation of the printing process, it should also be noted that adding illumination is not without risk itself, as it is important to avoid adding in any energy that may result in curing of the resin which would result in a degradation of the fidelity of the printing process.

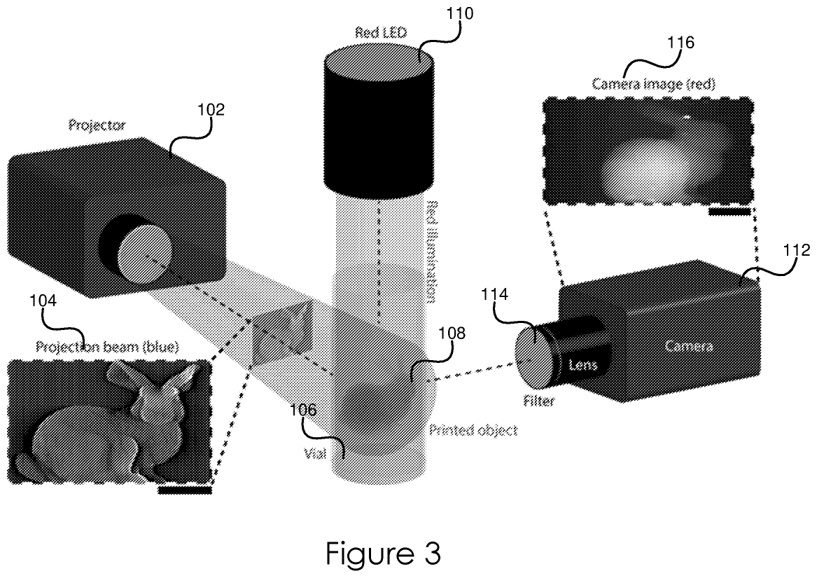

To address these issues. A control system 100 that makes use of imaging of the resin within the reservoir during the printing process is illustrated in FIG. 3. As with earlier VAM systems, a projector 102 is used to generate images 104 that are projected into a reservoir 106 to selectively cure resin within the reservoir 106 to form an object 108. Off axis to the projector 102 is a light source 110 that illuminates the object 108 within reservoir 106 using a light distinct from the wavelengths transmitted by projector 102. In one example, the projector 102 will use light that ranges from blue to ultraviolet, while light source 110 will provide a red light, which optionally may be narrowly centered around a wavelength of 624 nm. Red light from light source 110 is subjected to scattering when it passes from the unset resin within reservoir 106 into the surface of object 108. Scattering may be observed throughout the volume of object 108, not just at its surface. This scattering is detected by a camera 112, which generates an image 116. Image 116 is representative of the current state of the printed object 108. It should be understood that in the illustrated embodiment, camera 112 is arranged to be off axis to both projector 102 and light source 110. In a non-limiting embodiment, each of the projector 102, the light source 110 and the camera 112 are mutually orthogonal, which can effectively provide the equivalent of x-y-z axes. It should be understood that these axes do not need to be mutually orthogonal, but it may simplify mathematical modeling, and thus control methods. Furthermore, it should be noted that in the illustrated embodiment, the origin of the axes is within the reservoir 102, and may represent the center of the printed object 108. To ensure that each side of the printed object 108 can be exposed to the projector 102, the reservoir 106 can be rotated. By arranging the direction of rotation, it is possible for camera image 116 to be used to control the projector 102 so that image 104 is adjusted to account for the current state of printed object 108.

To reduce the likelihood of environmental light, or light from projector 102 impairing the imaging functions of camera 112, an optional filter 114 can be used with camera 112. In the illustrated embodiment, a filter can be matched with the light source 110 so that, for example, light between 620 nm and 630 nm is allowed to pass through filter 114, allowing camera 112 to only capture the light from light source 110 that is scattered by object 108.

Using the images 116 captured by camera 112, the model that is used to generate images 104, and an understanding of how far into the printing process the object 108, it is possible to determine how close the form of object 108 is to the expected form based on the model. Based on the existing form of object 108, adjustments can be made so that when the side of object 108 facing camera 112 is rotated to face projector 102, the image 104 projected will be based on both the existing form of object 108 and the expected state of the object 108. Amongst other benefits, this feedback based control can aid in the prevention of overexposure that would reduce the quality of the final print.

The ability to adjust the images 104 transmitted by projector 102, including the ability to terminate printing, is in contrast to prior art system that do not enable real-time control and instead allow for refinements to the printing process through analysis of finished printed objects so that changes can be made in subsequent printing processes. It should be noted that the kinetics associated with the curing process may vary between resins, and may even vary between different production batches of the same resin. This can impair the ability to make changes to a process based on previous prints. By relying upon real-time or near-real-time feedback, such as that generated in accordance with the scattering of light from light source 110 caused by the curing the resin, feedback based control within VAM system 110 allows for an improved printing process.

It should be understood that a variety of modifications can be made to printing system 100 including fixing the reservoir 106, and instead having both projector 102 and camera 112 rotate about the reservoir 102. In some embodiments, light source 110 may also rotate, especially in embodiments where the camera 112 and light source 110 are not arranged to be at right angles to each other.

As noted earlier, the illustrated embodiment makes use of a projector 102, light source 110 and camera 112 that are arranged to be mutually orthogonal. In some embodiments these elements may not be arranged at right angles to each other. The placement of light source 110 and the camera 112 may be constrained by the requirements associated with how the cured resin scatters light. Adjustments to the placement of these three elements may result in a requirement to change parts of the control methods that will be discussed below in more detail.

The wavelengths of light emitted by projector 102 are associated with the properties of the selected resin. As noted above, in the illustrated embodiment, wavelengths of light between blue light and ultra-violet light are used because these are the wavelengths of light that cause the resin to cure. The wavelengths of light emitted by light source 110, in the illustrated embodiment, are selected to avoid overlap with any of the wavelengths that can cause curing of the resin. In the illustrated embodiment, light source 110 emits light with a wavelength centered around 624 nm, possibly with 5-10 nm on either side of the center wavelength. This wavelength may change based on the ability of camera 112 to record images in this wavelength band, and the response of the resin to the wavelength. It should also be noted that filter 114 is matched to the wavelength of the light source 110.

It should be noted that some resins emit light as part of the curing process. This light is in a different wavelength band than the light that caused curing of the resin. In some embodiments, it may be possible to use this emitted light as part of the imaging process. The light source 110 could be selected to emit light in the same or a similar wavelength in some embodiments. In other embodiments, the camera 112 can be designed to capture light in both the wavelengths emitted by light source 110 and the wavelengths emitted by the curing resin. This may be accomplished through the use of two cameras set to capture light in these two different wavelength bands, with an additional processing step to merge information from both cameras.

In contrast with the illustrated prior art systems, it should be understood that the system 100 of FIG. 3 makes use of a light source 110 that illuminates the object 108 with a different wavelength of light than is transmitted by projector 102. By having different wavelengths of light used to illuminate the object 108 and to photocure the resin, imaging by camera 114 does not need to rely upon detecting changes in the refractive index of the resin by measuring small changes in the offsetting of an axis. Light from light source 110 is oriented along a different axis than the principal axis of the camera 114. This allows camera 114 to capture information associated with how light from light source 110 is scattered by the object 108. This information may be representative of an intensity of light reflected by the object 108 as it forms. As noted elsewhere, the scattering can occur throughout the object 108 giving information about the structure of the object 108 and not just the surface shape. The scattering information is thus reflective of how the object 108 is forming. The scattering information can be understood to represent how the structure of object 108 is evolving, and is not a direct measure of the changes of the refractive index of the resin associated with the changes of the trajectory of light through uncured resin.

It will be appreciated that, in the illustrated embodiments, to measure scattering of light from light source 110, camera 114 is not oriented along the same axis as light source 110. By having different axes, at least a portion of at least one surface of object 108 can scatter light for capture by the camera 114. This can be used to generate a model of the surface of the object 108 (as will be discussed below) that allows for a comparison of the object 108 to a model of the object. In the illustrated configuration, light source 100 and camera 114 have orthogonal axes. It should be appreciated that while substantively orthogonal axis may allow for simplification of post-processing of the images, different configurations where the light source 110 and camera 114 have independent axes, but are not orthogonal, are possible. It should be understood that in some embodiments, measurements of back scattering of light may be possible with a camera and light source aligned on the same axis. In some embodiments, the measurement of back scattering can be combined with the above-described capturing of other scattered light (including side scattered light) through the use of multiple cameras.

The orientation of the projector 102 to the light source 110 and camera 114 is not necessarily as limiting. In some embodiments, it may be beneficial to have the light source 110 and the projector 102 on independent and/or orthogonal axes. In the illustrated embodiment, it should be understood that the light from light source 110 will have a known wavelength, and will enter a reservoir 106 without having to first pass through a reservoir wall. The incident light from light source 110 refracts upon entry into the resin, and then scatters when it encounters the object 108. This scattering is captured by camera 114. By having the light source 110 and the projector 102 oriented on different axes, the shape of the object 108 can be captured by camera 114, from different angles. This allows for information about the shape of the object 108 to be captured so that it can be used as a control input to projector 102 before it projects an image 104 into the reservoir 106. In other embodiments, the light source 110 could be situated below the reservoir 106, or in another such location, so that light from the light source 110 is refracted through a wall of reservoir 106 before encountering object 108.

The use of camera 114 to capture scattering information allows for collection of information associated directly with the object 108. This information allows for controlling the image 104 output by camera 102 so that over printing, among other issues can be avoided or mitigated.

In the following discussion it should be understood that reference will be made to tomographic additive manufacturing (TAM), which should be understood to be a form of VAM. Particular techniques have been developed in the context of TAM that can be generalized for applicability to other VAM techniques using similar control systems. Reference to TAM should not be considered to be limiting, and is made solely for the purposed of a simplified explanation.

In TAM, a dose of light required to form an object is decomposed into a set of 2 dimensional patterns. These patterns are used to create images that can be projected into a reservoir of resin. This decomposition can be done using conventional tomographic principles. In some embodiments, the reservoir is a glass vial with known optical properties. The reservoir stores a photocurable resin responsive to a known wavelength of light. The reservoir is rotated about an axis, typically this axis of rotation is the central axis of a cylindrical reservoir, so that the resin can be exposed to a projector transmitting images representative of angular slices of a desired final object. These images are typically precomputed angular slices of the Radon transformation of a desired final object. When a local dose of projected light exceeds a gelation threshold within a set amount of time, the resin cures into a solid. It should be understood that in this process, the light applied to regions outside the volume of the final object cannot necessarily be avoided. This is one of the reasons that projection of light should be stopped when the final shape of the object has been formed, as excess projected light will cause over printing that may be difficult to remove later.

To contend with problems associated with this exposure time sensitivity, in TAM exposure time should be predetermined. In some embodiments an optimal exposure time can be determined, based on assumed characteristics of the resin. Because of these inconsistencies, feedback from a camera capturing the scattering of light can be employed to provide information representing direct visualization of a current state of the printing process. In-line print monitoring is a general challenge across all additive manufacturing techniques. Prior art print monitoring approaches focus on the quality of local material deposition instead of overall print geometry measurements. Because tomographic printing can be based on a model of the final state of the printed object, it is possible to compare an image of a partially printed object to an expected state of the object.

The techniques discussed below may also be referred to as Optical Scattering Tomography (OST), a term selected as an analogy to techniques known as Optical Projection Tomography. In OST, scattered light from the print volume can be imaged (potentially side scattered light) while the reservoir and associated object are rotated. This allows for a sinogram of each layer of the object to be built to enable subsequent tomographic reconstruction. At the beginning of a print, light scattering from the liquid resin (typically a monomer) is initially weak but increases as the polymer network begins to form during curing of the resin. This allows the geometry of the print to be monitored in real time to determine when the print is complete, or to determine changes to the image projected into the reservoir to cure the resin. The subsequent reconstruction can be performed by a reconstruction engine as will be discussed below.

By working with scattered light, a brightfield configuration of the imaging can be avoided, and instead a darkfield configuration can be achieved. It should be noted that this does not disqualify to use of a brightfield configuration as another control input.

OST can produce a high contrast signal due to a darkfield property. This contrast signal can be used to directly identify the print geometry. OST can be implemented using a monochrome light source to allow for simplified processing. This can also allow for an orientation agnostic approach to determining the print boundary, which may simplify the imaging of some internal or surface geometries.

The print projection system illustrated above in FIG. 3 makes use of a digital projector that projects light patterns through a rotating cylindrical glass vial containing a photocurable resin. The projected patterns are constructed such that a 3D light dose distribution corresponding to the desired print emerges in the resin after a number of rotations. Regions of high dose (i.e., inside the object region) solidify, while the dose in the remaining volume is below the gelation threshold and therefore these regions remain liquid. There is no explicit requirement for a refractive index matching bath around the print vial, though it is possible that some embodiments of a control system making use of the techniques discussed herein may take advantage of such a setup.

Light rays that may refract at the air/vial interface can be corrected for via Radon-space resampling derived from a detailed ray-tracing analysis. Light rays originating in the vial may undergo strong refraction as they exit the vial. Thus, light recorded by the camera is not necessarily composed of rays travelling parallel to the optical axis, as in traditional tomography. Instead, the direction of the light ray may vary across the field-of-view and the direction of these rays changes at the air/vial interface. This effect can be corrected for through the use of a resampling step to allow for tomographic imaging reconstruction. The resampling can allow for the as-imaged data to be captured into a standard Radon transform. This Radon transform can then be inverted using a standard Fourier back-projection (FBP) method to obtain the 3D reconstruction of the print.

This resampling step allows for the determination of a relationship between the coordinates of a virtual parallel beam projector and the physical projector. The virtual projector can represent a scenario where there is no refraction at the air-vial interface. If this were the case, the desired dose in the resin could be achieved by projecting the (filtered) Radon transform (or sinogram) of the object as the vial rotates. However, rays emitted by the physical projector are subject to refraction. By calculating the location of a general light ray on both projectors, a mapping between the two coordinate systems can be determined as follows:

$$( {x}_{p} , θ ) ↔ ( {x}_{v} ( {x}_{p} ) , {θ}_{v} ( {x}_{p} , θ ) ) \qquad ( 1 )$$

Here, xₚ is the horizontal coordinate of the physical projector and θ is the physical vial rotation angle; xᵥ is horizontal coordinate on a virtual projector, and θᵥ is the rotation angle of the virtual projector. The horizontal axis is approximately magnified, while the angular coordinate transform is more complex.

$${x}_{v} = {x}_{p}^{*} cos {θ}_{v} - \sqrt{{R}_{v}^{2} - {x}_{p}^{* 2}} sin {θ}_{v} \approx \frac{{n}_{1}}{{n}_{2}} {x}_{p} \qquad ( 2 )$$

$${θ}_{v} = {sin}^{- 1} ( \frac{{x}_{p}^{*}}{{R}_{v}} ) - {sin}^{- 1} ( \frac{{n}_{1}}{{n}_{2}} sin {θ}_{i} ) + θ \qquad ( 3 )$$

where θᵢ is the angle of incidence of the light ray on the vial, Rᵥ is the vial radius, and n₁ and n₂ are the refractive indices outside and inside the vial, respectively. The variable xₚ* takes into account the effect of the projector's throw ratio Tᵣ:

$${x}_{p}^{*} = {x}_{p} ( 1 - \sqrt{1 - α ( 1 - {( {R}_{v} / {T}_{r} W )}^{2} )} ) / α \qquad ( 3 )$$

$$where$$

$$α = 1 + {( {x}_{p} / {T}_{r} W )}^{2} ,$$

and W is the width of the projector. With this remapping in hand, the FBP-filtered sinogram S of the desired object can then mapped onto the physical projector space via a resampling step to obtain the resampled sinogram Sᵣ. Though in this discussion an FBP-filtered sinogram is used, it should be understood that projections calculated using iterative optimization techniques can alternatively be used as input to the resampling step. The resampled sinogram Sᵣ is then projected through the rotating vial with the physical projector to create the desired dose profile. The remapping step assures that the projected Sᵣ are predistorted to compensate for the in-plane refraction at the air/vial interface and the non-telecentricity of the projector.

The combination of projector non-telecentricity and air/vial refraction may result in a small compression (˜0.96-0.97x) of the projected image along the vertical dimension. This can be compensated for by a simple vertical stretching of the input geometry during slicing.

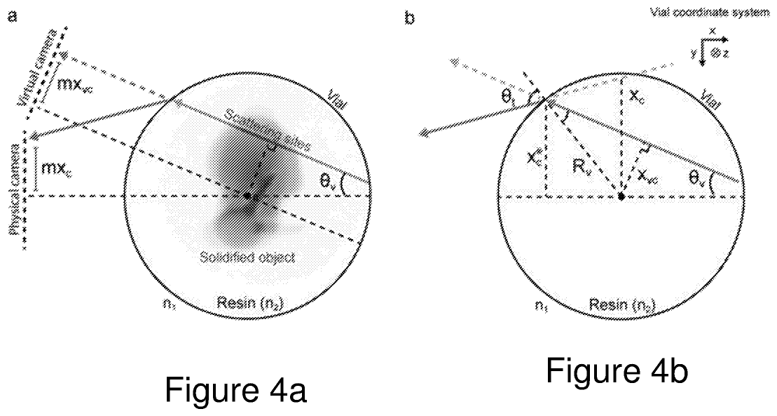

As shown in FIG. 3, the print vial/reservoir 104 is illuminated from above with a light source 110, that in the illustrated embodiment is an approximately collimated red LED source (SugarCube Red, 624 nm center wavelength). A camera 112, such as a FLIR USB3 Grasshopper outfitted with a lens (such as an Edmund Optics 25 mm/F1.8 #86572) and an optional filter, such as a 624 nm bandpass filter, images side scattered light from the contents of the vial. The optical axes of the camera, the projector, and red-light source in the illustrated embodiment are mutually orthogonal. As the vial 104 rotates during printing, the camera 112 records integrated scattering density projections through ray trajectories in the vial 104 as shown in FIG. 4a. This can be understood by tracing an arbitrary backwards-propagating ray from the camera 112 back through the vial 104. Every voxel in the vial intercepted by this ray is a potential scattering site that can contribute to the signal at the camera 112. The collection of side scattering images of the vial 104 over a full rotation comprises a full set of tomographic data suitable for 3D reconstruction of the scattering density. Imaging distortions caused by refraction at the air/vial interface and the non-telecentricity of the imaging system may violate the parallel beam assumption needed for FBP reconstruction. As with pattern projection, this can be compensated for if needed using resampling to remove the distortion before FBP reconstruction.

As seen in FIGS. 4A and 4B, the red ray in the vial may indicate possible scattering sites that contribute to the signal recorded at a particular pixel on the camera at the positions indicated by the solid and dashed red rays outside the vial, respectively. The scalar factor m refers to the magnification factor of the camera+lens system. The solidified object acts as a source for scattering events though its entire volume.

A ray tracing diagram for an arbitrary ray impinging on a camera pixel is shown in FIG. 4b. For imaging, physical and virtual camera coordinates x_{c} and x_{vc} can replace the projector coordinates xₚ and xᵥ, and the angle of incidence θᵢ can then replace the angle of transmission θₜ. Furthermore, the non-telecentricity on the imaging side is more conveniently described using the distance from the camera to the vial centre D instead of the projector throw ratio. The remapping for imaging can be found by a substituting the physical and virtual camera coordinates x_{c} and x_{vc} for the projector coordinates xₚ and xᵥ in Equations 2-4:

$${x}_{vc} = {x}_{c}^{*} cos {θ}_{v} - \sqrt{{R}_{v}^{2} - {x}_{c}^{* 2}} sin {θ}_{v} \approx \frac{{n}_{1}}{{n}_{2}} {x}_{c} \qquad ( 5 )$$

$${θ}_{v} = {sin}^{- 1} ( \frac{{x}_{c}^{*}}{{R}_{v}} ) - {sin}^{- 1} ( \frac{{n}_{1}}{{n}_{2}} sin {θ}_{t} ) + θ \qquad ( 6 )$$

$$where$$

$${x}_{c}^{*} = {x}_{c} ( 1 - \sqrt{1 - {α}_{i} ( 1 - {( \frac{{R}_{v}}{{x}_{c}} tan ( {x}_{c} / D ) )}^{2}} ) / {α}_{i} \qquad ( 7 )$$

$${α}_{i} = 1 + {( tan ( {x}_{c} / D ) )}^{2} \qquad ( 8 )$$

$${θ}_{t} = {sin}^{- 1} ( \frac{{x}_{c}^{*}}{{R}_{v}} ) + {tan}^{- 1} ( \frac{{x}_{c}^{*}}{D} ) \qquad ( 9 )$$

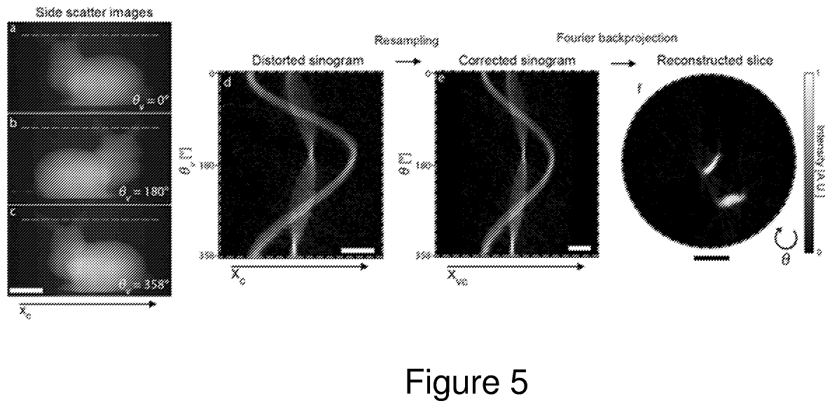

After obtaining the imaging remapping, the 3D scattering density in the vial 104 can be reconstructed. This process is illustrated in FIG. 5. Side scatter images a-c show images during a print of a Stanford Bunny with diurethane dimethacrylate (DUDMA) resin at three different vial rotation angles during a full vial rotation (angular sampling step is 2°). From the stack of images of a full rotation, a distorted sinogram is extracted for each z-slice. One such slice is shown as image d in FIG. 5, where the location of the slice is indicated by the dashed horizontal lines in images a-c. This sinogram, which is distorted by vial refraction and non-telecentricity and sampled in (x_{c},θᵥ)-space, can then be remapped to (x_{vc},θ)-space (Radon space) to produce the undistorted sinogram shown in image e. This undistorted sinogram can then be back-projected via FBP to create a reconstructed OST slice in vial space as shown in image f. This reconstructed slice represents the scattering density within this 2D slice of the vial. The 3D scattering density field in the vial is obtained by repeating this process for all horizontal slices in the print vial. Any distortions resulting in either expansions or contractions can be adjusted for by adjusting the vertical magnification factor.

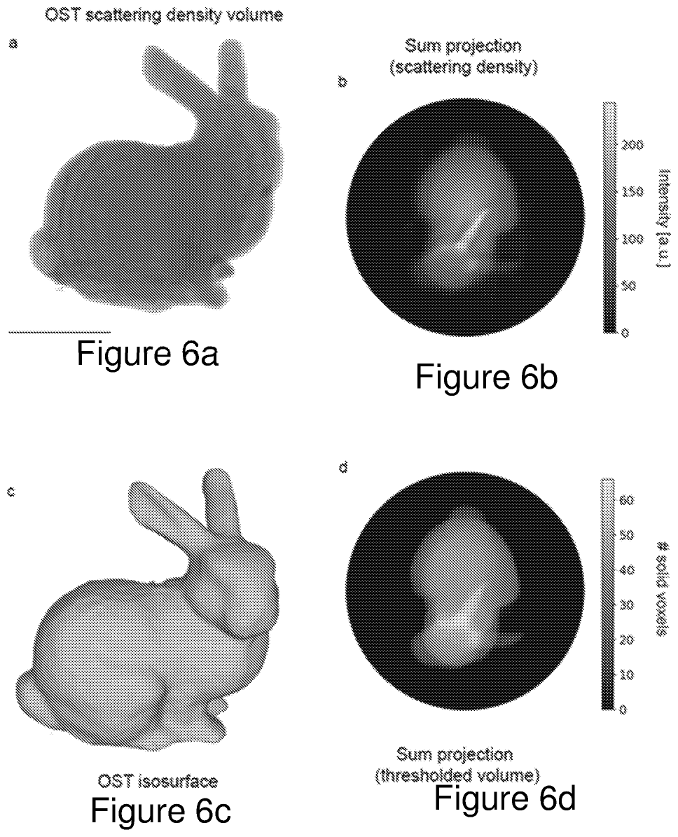

A volumetric visualization of the 3D scattering field for the Stanford bunny print in FIG. 5 is shown in FIG. 6a, along with an overhead sum projection image in FIG. 6b. These data capture the volumetric nature of the imaging data. To provide more information, an isosurface rendering, as provided in FIG. 6c, can be used to represent surface geometry. For each resin used a different OST intensity value corresponding to the gelation threshold, Iₚ can be determined by printing a standard cylinder. By setting the isosurface threshold at Iₚ, the surface corresponding to the actual polymerized object is rendered. If the isosurface threshold is set below this value, an isosurface larger than the actual print may be obtained. Similarly, a smaller isosurface threshold will result in an isosurface smaller than the actual print. Alternatively, the object can be visualized by setting the threshold of the scattering volume at Iₚ and setting voxels over this value to 1. The subsequent overhead sum projection of this threshold volume is shown in FIG. 6d, which can also be generated in real-time. A print termination time can then be defined by either an operator when this live visualization of the print qualitatively matches the known reference geometry or through an automated process comparing the imaging of the print to an expected shape defined by the model.

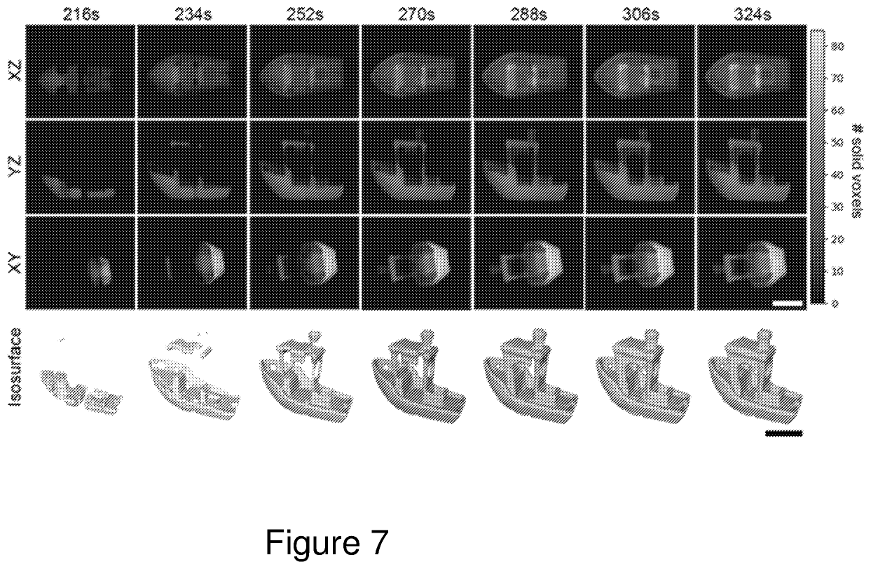

The temporal resolution afforded by OST can uncover interesting polymerization dynamics at play in tomographic printing. FIG. 7 shows the evolution of a Benchy print during rotations 12-18 (216 s-324 s). This series of renderings illustrates phenomena that are common occurrence across many geometries: larger features (such as the boat hull) appear first, followed by fine features (such as the thin walls of the boat cockpit). This may be attributable to a combination of oxygen diffusion and optical point spread function effects, though the actual causes are not necessarily relevant to the OST techniques. To the right of each isosurface rendering in FIG. 7, is a projection of the OST volume for each timepoint. From this series of overhead projections, the operator can clearly observe missing features at early print times, and adjust the total print time as needed. OST volumes can be computed asynchronously in a parallel core from pattern projection and updated dynamically. Typical volume computation time is ˜8-9 s, corresponding to approximately half of a vial rotation.

OST can provide both live 3D imaging of the tomographic additive manufacturing process, as well as metrics associated with differences between the expected print form and the actual printed form. This can be presented to an operator, or used as an input to a control system. OST uses the scattering arising from the micro-scale refractive index mismatch between a resin, such as a liquid monomer, and solid polymer as an optical contrast mechanism. The 3D reconstruction of the scattering density inside the reservoir is enabled by tomographic sampling and a resampling process similar to that used in the projection step for a non-index-matched tomographic printing system. The scattering density that corresponds to gelation can be reliably calibrated, resulting in accurate print reconstruction using a physically motivated isosurface threshold. Because OST relies on scattering contrast as opposed to ray deflection, more strongly scattering resins are also compatible with OST.

OST imaging can be used to improve ease of use for tomographic printers by providing crucial feedback of the progress of the print. This information can be used as an input to a control process or visually presented to the operator. OST can be used to reduce or eliminate the need for time consuming ex-situ metrology such as x-ray CT (3D), laser scanning (3D) or profilometry (2D+height).

The in-situ nature of OST print imaging also allows the user to disentangle the source of print failures by pinpointing whether the error occurred during printing or post-processing. If the print issue can be traced back to the print itself, OST can be used to determine when and where it occurred during printing, something which may not be possible or feasible in prior art techniques. OST may also be used to determine information in studying photopolymerization kinetics which may aid in optimizing resin formulations and achieving industry-standard print fidelity in tomographic additive manufacturing.

In the above discussion, focus has been directed to the use a projector that projects images into a photocurable resin using light at blue and ultraviolet wavelengths (e.g. light with a wavelength between 100 nm and 500 nm.) Because the resin is designed to cure when exposed to this wavelength of light, the light source is designed to make use of different wavelengths of light for illumination. To avoid any possible overlap, some embodiments will use a light source in the red-to-near-infrared wavelength region (e.g. light between 600 nm and 850 nm). It should be understood that illumination can be performed using any range of wavelengths outside the range that causes photocuring of the resin, and that it within the imaging capability of the selected camera. In some embodiments the light source could use wavelengths of light between 550 nm (roughly corresponding to yellow light) to 1000 nm (infrared light). If it is used, the optional camera filter can be matched to the wavelengths used for illuminating the object.

Different resins will cure in response to exposure to different wavelengths of light. If a resin includes so-called upconverting particles, light at a given wavelength can be absorbed by the upconverting particle and re-emitted at a wavelength that causes photocuring. These compounds can be used with a blue-UV sensitive resin to increase the set of wavelengths that cause photocuring. In such a case, the selection of the wavelengths used for illumination may be restricted. Other dopants can be used that will trigger a localized heating process that may aid in the photocuring process. Although discussions above have been focused on a resin that cures with exposure to blue-UV light, other resins may cure with exposure to different wavelengths. Resins that cure as a result of localized heating may be responsive to red and near-infrared wavelengths, and may not respond to exposure to blue light. In systems using such resins, the projector may project images using red-infrared wavelengths and may perform imaging using blue light (or another color of light other than those to which the resin is sensitive).

It should be understood that the above described system allows for an initial model of an object to be used to images to be projected by a projector. These images cause the resin to begin to cure. A light source illuminates the object as it forms, and light from the light source scatters when it interacts with the object. This scattered light is captured by a camera, and a set of these images can be used by a reconstruction engine to assemble a model representing the current state of the forming object. It should be understood that the reconstruction engine can be embodied by a computing system using images from the camera as an input, and assembling the model of the forming object using the techniques discussed above. This model representative of the forming object can be an isosurface, as discussed above.

The reconstruction engine receives, as its input, images captured by the camera. Each image is representative of the structure of the object at the moment of its capture, from the perspective of the camera. This can be thought of as a two-dimensional projection of the object as it is forming from a given viewing perspective. As the camera rotates about the object, or as the object rotates about an axis fixed with respect to the camera position, more images are captured. This set of images can be assembled into an image of the object from each of the perspectives. By having a sufficient number of images captured, the two-dimensional images can be assembled into a three dimensional model using a number of different known techniques within the reconstruction engine. In some embodiments, ray tracing may be used to adjust the assumed coordinates of a scattering point to account for refraction caused as the scattered light passes through changes in the refractive index between the resin and reservoir, and between the reservoir and the air surrounding it. It should be noted that this may involve the use of at least one of equations (2)-(4) and equations (5)-(9). From the set of images capturing the scattering information, a 3D scattering density can be assembled. This may take the form of a distorted sinogram for different slicings. A corrected sinogram can be built based on a remapping of the distorted sinogram into a Radon space. These corrected sinograms can be used to reconstruct a model of the object by building a set of slices representing the scattering density of a given slice, and then by assembling the 3D model using the set of 2D slices.

The instructions to perform this reconstruction can be stored as processor executable instructions on a storage medium, where they can be accessed by a processor and executed. The computing platform on which the reconstruction engine is embodied may make use of one or more general purpose processors such as central processing units (CPUs) and may also include a number of application specific processors, such as graphics processing units (GPUs). The CPUs and GPUs may be designed around a single core, or they may make use of a plurality of cores. In embodiments in which multiple cores are used, it should be understood that different cores may be of different sizes to allow for optimization of the processor for a set of intended tasks. Running on such a platform, the reconstruction engine may make use of network interfaces, both wireless and wired, so that information can be received from a camera, and data can be stored for use in processing. There may be either an interface to other systems, or a display for rendering information for use by an operator.

To provide information useable by an operator of the VAM system, graphical representations of the model of the forming object can be presented so that the operator can decide when to stop the printing process. In some configurations, a further automation can be provided by having an output of the reconstruction engine serve as an input to a comparison engine, which can generate images or metrics showing the difference between the initial model and the model of the forming object. This, in effect, allows for a comparison of an idealized target to the actual object. Where a control process is carried out, for example by a computer based VAM controller, the comparison data can be used to either modify the images projected by the projector (to account for differences between an expected shape of the object at a given stage and the actual shape of the object as reflected by the output of the reconstruction engine). The comparison data can also be used as an input to the VAM control system to allow for the automated stopping of the printing process. Those skilled in the art will appreciate that the algorithms to implement such control can vary based on the particulars of implementation.

In the instant description, and in the accompanying figures, reference to dimensions may be made. These dimensions are provided for the enablement of a single embodiment and should not be considered to be limiting or essential. The sizes and dimensions provided in the drawings are provided for exemplary purposes and should not be considered limiting of the scope of the invention, which is defined solely in the claims.

1. An optical scattering tomography (OST) system for imaging an object, within a resin reservoir, formed by light from a projector, the OST system comprising:
a light source for illuminating the object within the resin reservoir with light having a known wavelength;
a camera for capturing an image associated with scattering of the light from the light
source by the object in the resin reservoir; and
a reconstruction engine for assembling a model representative of the object in accordance with a plurality of captured images from the camera, where the light source and the camera are oriented along independent axes.

2. (canceled)

3. The optical scattering tomography system of claim 1 wherein the light source and the camera are oriented along substantially orthogonal axes.

4. The optical scattering tomography system of claim 1 wherein each of the projector, the light source and the camera are oriented along mutually orthogonal axes.

5. The optical scattering tomography system of claim 1 wherein the light source is one of a Light Emitting Diode, a laser, and a filtered light source.

6. The optical scattering tomography system of claim 1, provided in a kit with the projector, wherein the projector projects an image into the resin reservoir, the image determined in accordance with the model of the object.

7. (canceled)

8. The optical scattering tomography system of claim 1 wherein the light from the projector has a wavelength between 100 nm and 500 nm, and this wavelength is different than the known wavelength of the light from the light source.

9. (canceled)

10. The optical scattering tomography system of claim 1, provided in a kit, the kit further comprising a resin for loading into within the resin reservoir, the resin being photocurable in response to exposure to a wavelength of light associated with the light from the projector, and not photocurable to the known wavelength of light from the light source.

11. The optical scattering tomography system of claim 10 wherein the resin is photocurable in response to exposure to a wavelength of light between 100 nm and 500 nm, and wherein the known wavelength of light associated with the light source is between 550 nm and 1000 nm.

12. The optical scattering tomography system of claim 1, wherein at least one of the known wavelength of the light from the light source is between red and near-infrared and the wavelength is between 620 nm and 630 nm.

13. (canceled)

14. The optical scattering tomography system of claim 1, further comprising a spectral filter between the reservoir and the camera.

15. The optical scattering tomography system of claim 14 wherein the spectral filter is a bandpass filter that passes light having a wavelength between 620 nm and 630 nm centered about the known wavelength the light from the light source.

16. (canceled)

17. The optical scattering tomography system of claim 1, in a kit, further comprising a rotational stage for rotating wherein the resin reservoir rotates with respect to the camera and the projector.

18. The optical scattering tomography system of claim 1, wherein the reconstruction engine generates the model in accordance with three dimensional scattering density information determined in accordance with a plurality of images captured by the camera.

19. The optical scattering tomography system of claim 1, wherein the assembled model representative of the object is an isosurface representative of the object.

20. The optical scattering tomography system of claim 18, wherein the three dimensional scattering density information includes information associated with the brightness of light scattered by the object.

21. The optical scattering tomography system of claim 1, wherein the output of the reconstruction engine is displayed to an operator, as a graphical representation of the isosurface and the model; or as a numerical representation of the difference between the model and the isosurface.

22. (canceled)

23. (canceled)

24. The optical scattering tomography system of claim 1, wherein the output of the reconstruction engine is provided as an input to a projector control system.

25. The optical scattering tomography system of claim 24 wherein the projector control system terminates the projection of light into the reservoir in accordance with the output of the reconstruction engine.

26. The optical scattering tomography system of claim 24, wherein the projector control system controls light output by the projector in accordance with the model of the object and the output of the reconstruction engine.

27. The optical scattering tomography system of claim 1, further comprising a comparison engine for generating an output representative of a difference between a model of the object and the isosurface assembled by the reconstruction engine.
